(19) United States
(12) Patent Application Publication
(10) Pub. No.: US 2017/0337618 A1
(43) Pub. Date: Nov. 23, 2017

(54) VEHICLE REFUELING MANAGEMENT

(71) Applicant: Ford Motor Company, Dearborn, MI (US)

(72) Inventor: Gahl Berkooz, Ann Arbor, MI (US)

(73) Assignee: Ford Motor Company, Dearborn, MI (US)

(21) Appl. No.: 15/159,934

(22) Filed: May 20, 2016

(51) Int. Cl. G06Q 30/06; B60R 16/023; G01C 21/34; G06Q 50/30

(52) U.S. Cl. CPC G06Q 30/0639; G01C 21/34; B60R 16/0236; G06Q 50/30

(57) ABSTRACT

Data is received from each of a plurality of vehicles in a group of vehicles indicating fuel consumption of each vehicle over a past period of time. An aggregate fuel consumption for the vehicles, and one or more fuel prices, is predicted for a future period of time. According to the predicted fuel consumption and one or more fuel prices, one or more fuel futures contracts are selected for purchase.

### BACKGROUND

Vehicle drivers may consider fuel prices and/or availability in determining whether and where to drive. For example, when gasoline prices increase, vehicle drivers may be inconvenienced and may modify their driving patterns, e.g., by driving less or by not driving at all.

### DRAWINGS

FIG. 1 illustrates an exemplary vehicle system for operating a vehicle.

FIG. 2 is a block diagram of an exemplary refueling management system.

FIG. 3 is a diagram of an exemplary process for establishing and/or managing a fuel management system.

FIG. 4 is a diagram of an exemplary process that may be implemented in a server for managing fuel acquisition.

FIG. 5 is a diagram of an exemplary process that may be implemented in a computer of the vehicle for refueling management.

### DETAILED DESCRIPTION

### Introduction

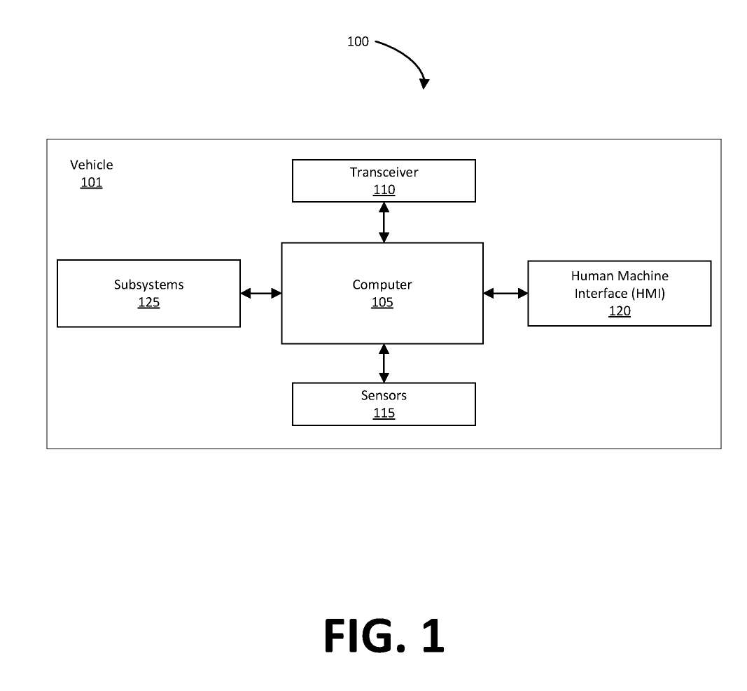

FIG. 1 is a block diagram of an exemplary vehicle system 100 for operating a vehicle 101. The vehicle 101 may include a computer 105 that includes or is communicatively coupled to a transceiver 110, sensors 115, a human machine interface (HMI) 120, and/or vehicle 101 subsystems 125, e.g., steering, brakes, throttle, etc. The computer 105 may receive data relating to operating the vehicle 101, and may generate commands for operations of the vehicle 101, including to make a change or adjustment to a mode of operating the vehicle 101, e.g., based on refueling needs and/or opportunities.

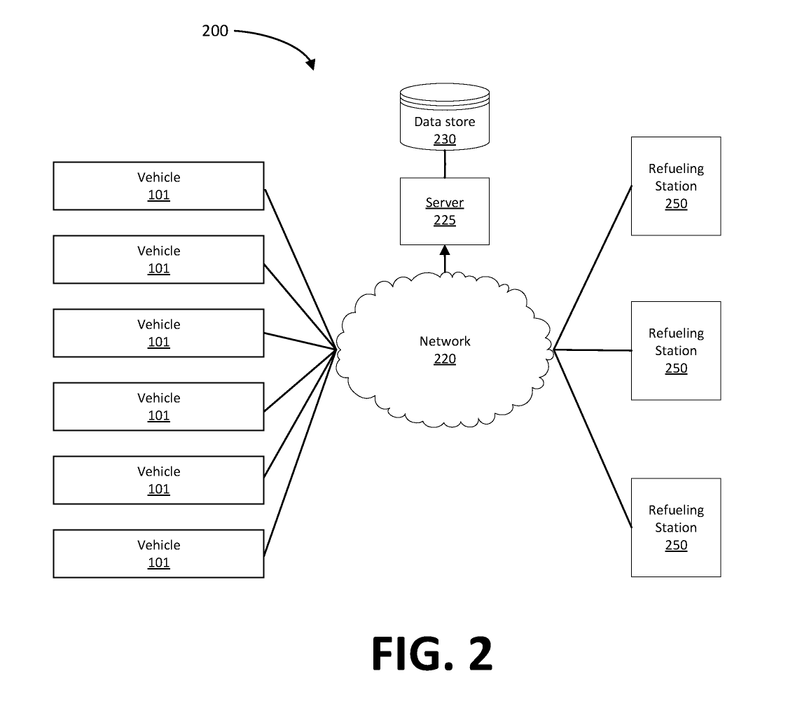

FIG. 2 is a block diagram of an exemplary refueling management system 200. The system 200 may include many vehicles 101 and/or one or more of a refueling station 250, a server 225, and a data store 230. The system 200 may include one or more communications mechanisms, e.g., the vehicle 101 may include a transceiver 110, for communicating via a network 220.

The server 225 may determine a predicted fuel, e.g., gasoline, cost for a vehicle 101 and/or vehicle 101 operator, and offer the operator enrollment in the system 200 to protect the vehicle 101 operator from a change in the price of fuel. The server 225 may identify one or more refueling stations 250, participating in the system 200, at which the vehicle 101 may refuel. The vehicle 101 computer 105 may determine a route to the refueling station 250.

### Exemplary System Elements

The vehicle 101 typically includes a computer 105. The computer 105 may be communicatively coupled to or include one or more electronic control units (ECUs), e.g., controllers or the like included in the vehicle 101 for monitoring and/or controlling various vehicle components, e.g., an engine control unit (ECU), transmission control unit (TCU), etc. The computer 105 may be generally configured for communications on a controller area network (CAN) bus or any other suitable protocol such as JASPAR, LIN, SAE J1850, AUTOSAR, MOST, etc. Electronic control units, sensors, etc., may be connected to communications mechanisms, e.g., the CAN bus, as is known. The vehicle 101 may also include one or more electronic control units specifically for receiving and transmitting diagnostic information such as an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, etc. Alternatively or additionally, in cases where the computer 105 actually comprises multiple devices, the CAN bus or the like may be used for communications between devices represented as the computer 105 in this disclosure, e.g., various ECUs.

The vehicle 101 may include a transceiver 110, i.e., a mechanism such as is known for the vehicle 101 computer 105 to send messages to and/or receive messages via the network 220. The transceiver 110 may transmit and/or receive messages using a plurality of communication protocols. For example, the transceiver 110 may transmit and/or receive messages using protocols such as Dedicated Short Range Communication (DSRC), cellular modem, and short-range radio frequency. The transceiver 110 may be in communication with the computer 105, such that the computer 105 can process the message transmission and/or receipt by the transceiver 110.

The transceiver 110 may transmit and/or receive kinematic data, i.e., data relating to motion, regarding vehicles surrounding the vehicle 101. For example, the kinematic data may include the velocity of each of the vehicles surrounding the vehicle 101, including the velocity of the vehicle 101. The kinematic data may further include an acceleration, a steering angle, and a path history of the vehicles surrounding the vehicle 101.

The transceiver 110 may communicate with a network 220 that extends outside of the vehicle 101, e.g., communicating with the server 225. The network 220 may include various wired and/or wireless networking technologies, e.g., cellular, Bluetooth, wired and/or wireless packets, etc. The network 220 may have any suitable topology, e.g., bus, point-to-point, hybrid, etc. Exemplary communication networks include wireless communication networks (e.g., using Bluetooth, IEEE 802.11, etc.), local area networks (LAN), and/or wide area networks (WAN), including the Internet, providing data communication services.

The vehicle 101 may include a variety of sensors 115. The sensors 115 may be linked to electronic control units and operate within a CAN bus protocol or any other suitable protocol, as described above, and as is generally known. The sensors 115 may both transmit and receive data. The sensors 115 may communicate with the computer 105 or other electronic control unit via e.g., the CAN bus protocol, to process information transmitted from or received by the sensors 115. The sensors 115 may communicate with the computer 105 or other electronic control unit via any suitable wireless and/or wired manner. By way of example, the sensors 115 may include any one or more of a camera, a RADAR unit, a LADAR unit, a sonar unit, a breathalyzer, a motion detector, etc. Additionally, the sensors 115 may include a global positioning system (GPS) receiver that may communicate with a global positioning system satellite connected to the network, etc.

The computer 105 may include one or more memory devices. A memory device may include a main memory device, i.e., a volatile memory device, and/or an auxiliary storage device that may be internal or external to the rest of the computer, e.g., an external hard drive. The memory device may communicate with the computer 105 and may store the data transmitted over the CAN bus protocol by the electronic control units. Individual data may be collected by the sensors 115, but subsequently, the aggregate data may be processed together by the computer 105. Data may also include data calculated and processed as an output by the computer 105. In general, data may include any data that may be gathered by a sensor 115 and/or processed by the computer 105.

The vehicle 101 may include a human machine interface (HMI) 120. The HMI 120 may allow an operator of the vehicle 101 to interface with the computer 105, with electronic control units, etc. The HMI 120 may include any one of a variety of computing devices including a processor and a memory, as well as communications capabilities. The HMI 120 may be a portable computer, tablet computer, mobile phone, e.g., a smart phone, etc., that includes capabilities for wireless communications using IEEE 802.11, Bluetooth, and/or cellular communications protocols, etc. The HMI 120 may further include interactive voice response (IVR) and/or a graphical user interface (GUI), including e.g., a touchscreen or the like, etc. The HMI 120 may communicate with the network 220 that extends outside of the vehicle 101 and may communicate directly with the computer 105, e.g., using Bluetooth, etc.

The vehicle 101 may include one or more subsystems 125. The subsystems 125 may include a brake system, a suspension system, a steering system, and a powertrain system. The subsystems may communicate with the computer 105, e.g., through the electronic control units and/or via the CAN bus protocol. The subsystems 125 may transmit and/or receive data from the computer 105, the sensors 115, the transceiver 110, and/or the HMI 120.

The network 220 may be communicatively coupled to one or more refueling stations 250, where vehicles may go for fuel refueling. The refueling stations 250 may include station sensors that identify when the vehicle 101 has entered the refueling station 250 premises. The refueling station 250 may also include station communication devices that may transmit and receive messages from the vehicle 101.

The server 225 may include a data store 230. Data received from the refueling stations 250 and from the vehicle 101 may be stored in the data store 230 in, e.g., standard query language (SQL), etc., for later retrieval. The vehicle 101 and the refueling stations 250 may thus retrieve data in the data store 230.

### Exemplary Process Flows

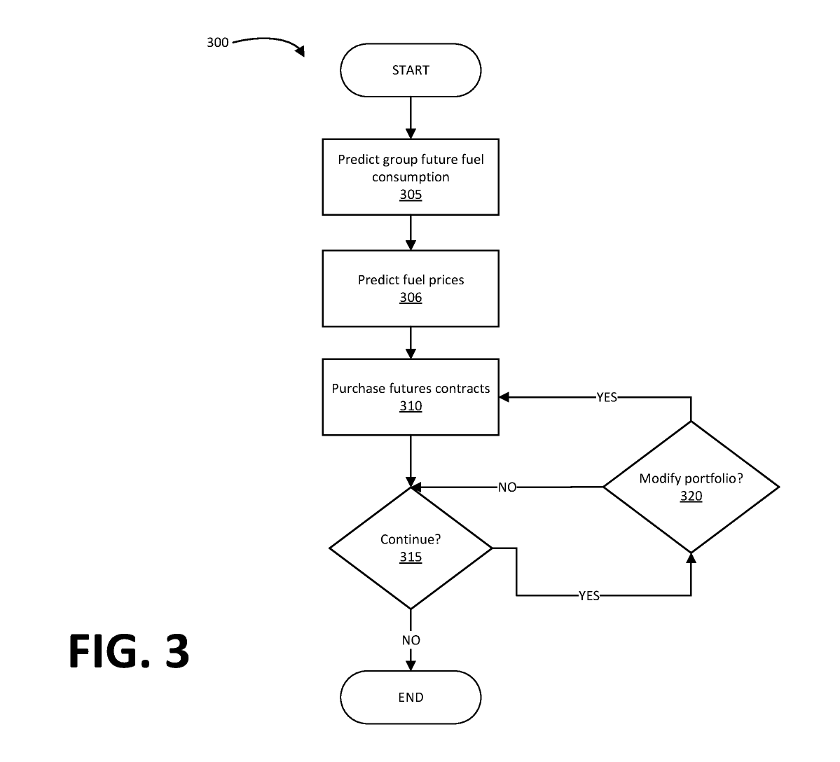

FIG. 3 is a diagram of an exemplary process 300 for establishing and/or managing a fuel management system 200. The process begins in a block 305, in which, e.g., according to programming in the server 225, a rate of future fuel consumption for a period of time are predicted for a group of vehicles 101. For example, vehicles 101 may provide data to the server 225, e.g., prior to and/or upon and after enrolling in the system 200, as described herein, e.g., below with respect to a block 405. Further, as also described herein, vehicles 101 may provide various data to the server 225 and during operation, and such data may be used to estimate the rate of future fuel consumption. A group of vehicles 101 may be identified according to vehicles 101 that have enrolled in the system 200 and/or that are predicted to enroll in the system 200. The goal of the block 305 is to estimate a total amount of fuel, e.g., in a geographic area or otherwise pertaining to the group of vehicles 101, needed for the period of time to satisfy fuel needs.

Next, in a block 306, the system 200, e.g., according to programming in the server 225, estimates fuel prices for the period of time. For example, the server 225 may receive estimated or predicted future fuel production data, e.g., from an industry analyst or data provider, from one or more fuel companies, i.e., participating in the system 200, etc. The predicted fuel production data may include, for example, the current and/or expected proportion of oil used in refineries of one or more fuel companies in the production of one or more respective fuel products, e.g., diesel fuel, premium gasoline, etc., relevant to fuel consumption of vehicles in the system 200, e.g., a vehicle 101 as described herein. The predicted future fuel production data may further include predicted fuel price changes independent from crude costs, refining costs, etc. e.g., environmental costs or the like.

Additionally or alternatively, the server 225 may receive financial data from any suitable provider, e.g., Bloomberg LP, CME Group, etc. The financial data may include, for example, general economic indicators and/or predictions, e.g., related to interest rates, employment levels, GDP, etc., and/or other indicators, historical and predicated prices, and/or analyst expectations, etc.

Next, in a block 310, the system 200 purchases one or more futures contracts, i.e., a portfolio of futures contracts, to satisfy the fuel needs estimated in the block 305, and based on the price(s) and/or price trends identified in the block 306, for the pertinent period of time, e.g., three months, six months, one year, etc.

Next, in a block 315, it is determined whether the process 300 should continue. For example, if the period of time is almost over, e.g., within one week, two weeks, one month, etc., of expiring, then a decision may be made to not further refine or modify the one or more futures contracts, whereupon the process 300 may end. Otherwise, the process 300 may proceed to a block 320.

In the block 320, a determination is made whether to modify the portfolio of one or more futures contracts established as described above with respect to the block 310. For example, fuel prices may have fluctuated in an unpredicted way, enrollment in the system 200 may have changed, etc. In one example, if predicted fuel consumption and/or predicted fuel prices deviate by more than a predetermined threshold, e.g., ten per cent, from actual prices or consumption, respectively, then the portfolio may be modified, i.e., one or more futures contracts may be purchased and/or sold.

If a determination is made to modify the one or more futures contracts, the process 300 returns to the block 310, wherein at least one of the one or more futures contracts are sold and/or purchased as appropriate. Otherwise, the process 300 returns to the block 315.

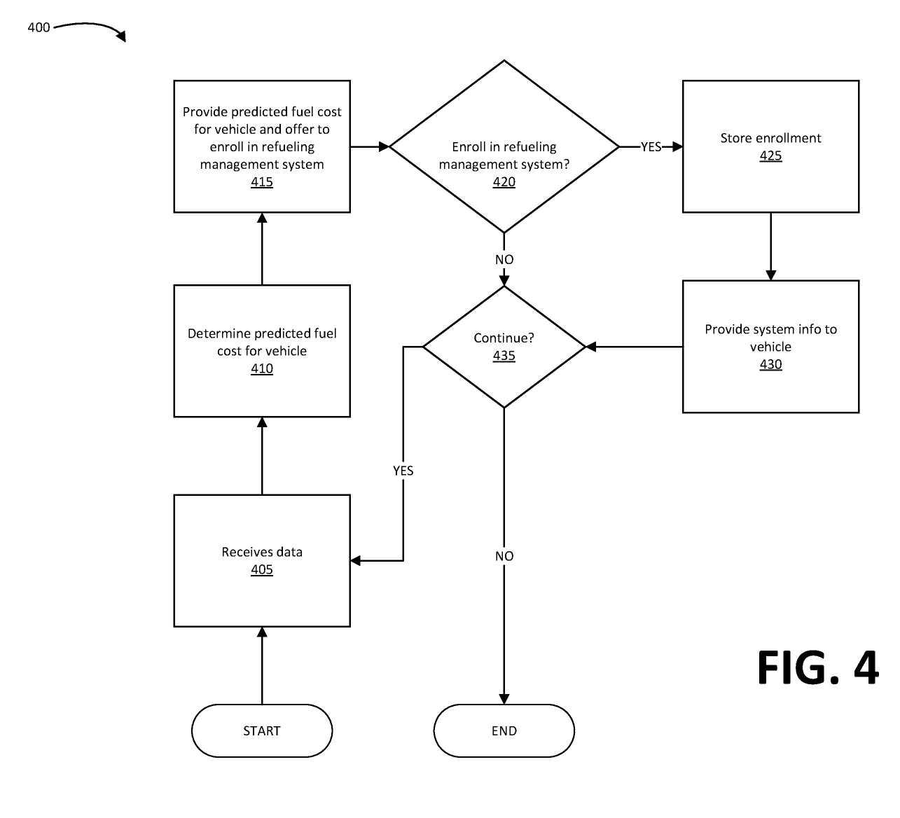

FIG. 4 is a diagram of an exemplary process 400 that may be implemented in the server 225 for managing fuel acquisition. Steps of the process 400 may be carried out by one or more of the server 225, the vehicle 101 computer 105, and/or both the server 225 and the computer 105.

The process 400 begins in the block 405, in which the server 225 receives data from one or more sources, typically via the network 220. For example, the server 225 may receive vehicle data collected from the vehicle 101 sensors 115. The sensors 115 may collect data that can be used to predict the rate of future fuel consumption of the vehicle 101, such as future travel path and kinematic data, i.e., data relating to the movement of the vehicle, e.g., the frequency and magnitude of acceleration, an average rate of fuel consumption such as miles per gallon, etc.

Additionally or alternatively, the vehicle 101 sensors 115 and/or HMI 120 may receive and/or determine constant data, i.e., versus variable data, e.g., data not prone to change, indicating a possible rate of future fuel consumption during specified periods of the vehicle 101. For example, the computer 105 may determine that on a particular day of the month vehicle 101 typically exceeds a normal daily fuel consumption by a predetermined threshold, e.g., by an amount that is statistically outlying, based on data for each month for the past year. The computer 105 may predict, based on this determination, a high probability of the vehicle 101 having correspondingly elevated fuel consumption during an upcoming period, e.g., the next three months, six months, etc. Alternatively, the vehicle 101 computer 105 may predict the rate of future fuel consumption by receiving input from the vehicle 101 operator through the vehicle 101 HMI 120.

Next, in a block 410, the data sent to the server 225 from the vehicle 101 sensors 115, the predicted fuel production data, and the financial data are used by the server 225 algorithm to determine the rate of future fuel consumption and future cost for the vehicle 101 for a period of time, e.g., the next three months, six months, etc. The algorithm may also be used by the server 225 to identify the one or more futures contracts that may be used by the vehicle 101 to reduce or eliminate risk of any change in the price of fuel.

Next, in a block 415, the server 225 sends to the vehicle 101 operator, e.g., to a user device, e-mail account, etc. of the operator, and/or to the vehicle 101 computer 105 for access via the HMI 120, the predicted fuel cost for the vehicle 101, along with an offer to enroll in the refueling management system 200. The server 225 may also send to the vehicle 101 economic data and/or predictions that may be used by the vehicle 101 operator. For example, economic data may indicate that there is a likelihood that the price of oil may decrease during a time interval, e.g., the time between the expected purchase of the fuel by the vehicle 101 and the offer to enroll in the refueling management system 200. The operator of the vehicle 101 may thus decline the offer to enroll in the refueling management system 200. However, should the economic data indicate that there is a likelihood that the price of oil may increase during the time interval, then the vehicle 101 operator may accept the offer to enroll in the refueling management system 200.

Therefore, in a block 420, the server 225 determined whether the operator, e.g., via one or more of a smartphone app, an e-mail message, the vehicle 101 HMI 120, etc. has accepted the offer to enroll in the refueling management system 200. If yes, process 400 proceeds to a block 425. Otherwise, the process 400 proceeds to a block 435.

The server 225, in the block 425, enrolls the vehicle 101 in the refueling management system 200. The server 225 further stores, e.g., in the data store 230, an identification of vehicles 101 enrolled in the refueling management system 200.

Following either the block 420 or the block 430, the server 225 and/or the vehicle 101 computer 105, in the block 435, determine/s whether the process 400 should continue. For example, the process 400 may end if the vehicle 101 turns off the function of the system 200, if the vehicle is switched off, etc. In any case, if the process 400 should not continue the process 400 ends following the block 435. Otherwise, the process 400 returns to the block 405.

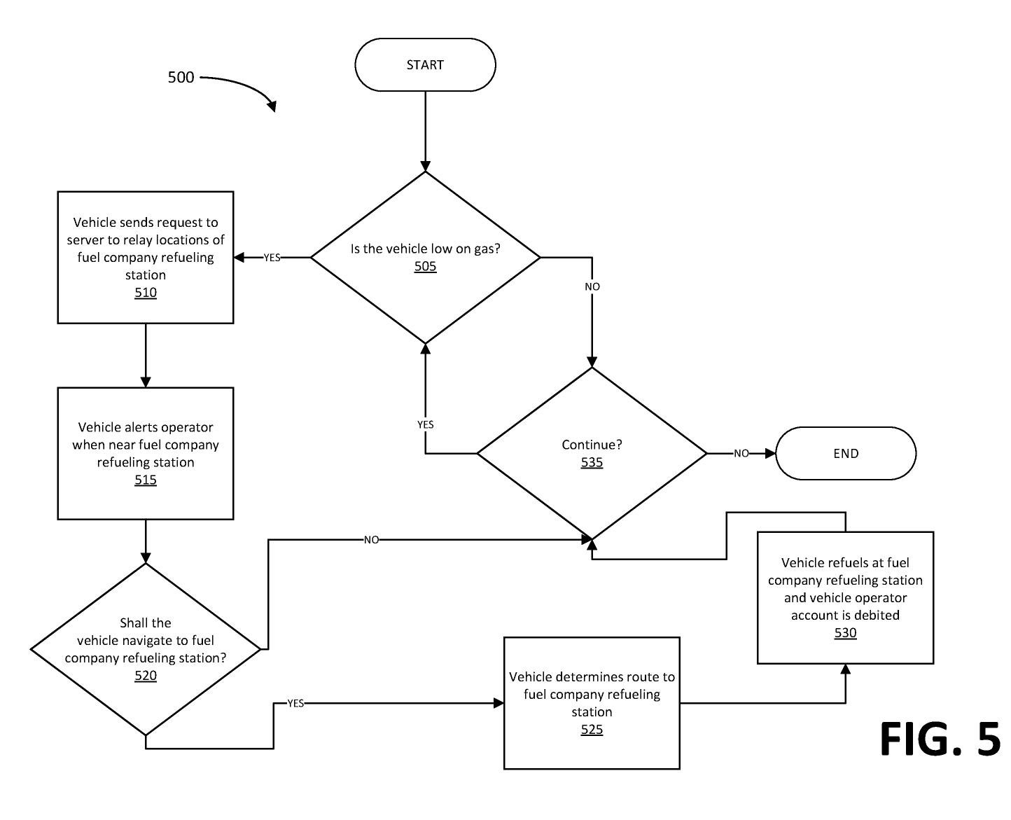

FIG. 5 is a diagram of an exemplary process 500 that may be implemented in the computer 105 of the vehicle 101 for locating and directing the vehicle 101 to the refueling station 250.

The process 500 begins in a block 505, in which the vehicle 101 computer 105 determines if the vehicle 101 is low on fuel. The vehicle 101 computer 105 may store, e.g., in memory, a threshold level of fuel in the vehicle 101 before the computer determines that the vehicle 101 is low on fuel. The computer 105 may be programmed to modify the threshold level. For example, the vehicle 101 computer 105 may determine that the vehicle 101 is low on fuel when the vehicle 101 fuel tank is half full, one-quarter full, etc. Should the vehicle 101 computer 105 determine that the vehicle 101 is low on fuel, the process 500 proceeds to a block 510. Otherwise, the process 500 proceeds to a block 535.

Should the vehicle 101 computer 105 determine that the vehicle 101 is low on fuel, the vehicle 101 computer 105, in the block 510, sends a request to the server 225 to relay locations of the refueling stations 250. Alternatively or additionally, the server 225 could have provided locations of refueling stations 250 in the system 200 to the vehicle 101 computer 105 ahead of time for storage in a memory accessible by the computer 105. In any case, the vehicle 101 computer 105 may display the locations on a visual interface, e.g., a map, etc., on the HMI 120 or other vehicle screen, such as the dashboard, heads-up display, etc.

Additionally or alternatively to displaying the locations received from the server 225, the vehicle 101 computer 105 may, in a block 515, alert the vehicle 101 operator when the vehicle 101 is near the refueling station 250. The vehicle 101 computer 105 may provide any suitable alert, such as visual signals, sounds, etc. The vehicle 101 computer 105 may display the alert on the HMI 120, for example.

Additionally or alternatively, in a block 520, the vehicle 101 computer 105 may prompt the vehicle 101 operator, e.g., via the HMI 120, whether the vehicle 101 shall navigate to the refueling station 250. Should the vehicle 101 determine to navigate to the refueling station 250, the process 500 proceeds to a block 525. Otherwise, the process 500 proceeds to the block 535.

Should the vehicle 101 determine to navigate to the refueling station 250, in the block 525, the vehicle 101 computer 105 determines the route to the most preferable, i.e., quickest, nearest, etc., refueling station 250. The vehicle 101 computer 105 may prompt the vehicle 101 operator whether to select the route to the refueling station. Yet further, it is possible that the computer 105 may implement in-vehicle controls to conserve fuel and/or to allow the vehicle 101 to reach a refueling station 250. For example, the computer 105 may implement speed and/or throttle controls to conserve fuel, shut down engine cylinders for more efficient operation. etc.

Following the block 525, in a block 530, the vehicle 101 refuels at the selected refueling station 250, i.e., determined as described with respect to the block 525. The fuel company refueling station may transmit and/or receive data relating to the system 200 from the server 225 and/or from the vehicle 101. For example, the vehicle 101 may transmit to the refueling station its intended arrival time to reserve fuel, provide payment information (e.g., relating to an account to be debited) in advance, etc. Alternatively or additionally, an account of the vehicle 101 operator is debited upon the vehicle 101 refueling. The vehicle 101 operator account may be kept by the system 200 server 225, e.g., for logistics such as modifying the one or more futures contracts and/or billing, etc., or may be a personal deposit account, e.g., at a bank that may directly withdraw the necessary funds, e.g., to cover the contractually agreed upon price of fuel, etc.

Next or following from either the block 505 or the block 520 or the block 530, in the block 535, the vehicle 101 computer 105 determines whether the process 500 should continue. For example, the process 500 may end if the vehicle 101 turns off the function of the system 200, if the vehicle is switched off, etc. In any case, if the process 500 should not continue the process 500 ends following the block 535. Otherwise, the process 500 returns to the block 505.

Computing devices such as those discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a computer having a processor and a memory, the memory storing instructions executable by the processor such that the computer is programmed to:
receive data from each of a plurality of vehicles in a group of vehicles indicating fuel consumption of each vehicle over a past period of time;
predict an aggregate fuel consumption for the vehicles, and one or more fuel prices, for a future period of time; and
according to the predicted fuel consumption and one or more fuel prices, select one or more fuel futures contracts for purchase.

2. The system of claim 1, wherein the computer is further programmed to provide an offer one or more of the vehicles in the group an opportunity to pre-purchase fuel based on the one or more futures contracts.

3. The system of claim 2, wherein the computer is further programmed to provide the offer to a vehicle in the group based at least in part on a prediction of the vehicle's fuel consumption for the future period of time.

4. The system of claim 2, wherein the computer is further programmed to provide, to vehicles that accept the offer, identification of one or more refueling stations from which pre-purchased fuel may be obtained.

5. The system of claim 2, wherein the computer is further programmed to provide, in response to a request from a vehicles that has accepted the offer, a route that includes one or more refueling stations from which pre-purchased fuel may be obtained.

6. The system of claim 1, wherein the computer is further programmed to determine whether one or more fuel prices have deviated from predicted fuel prices for the future period of time, and to initiate at least one of purchasing and selling fuel futures contracts based at least in part on the price deviation.

7. The system of claim 1, wherein the group of vehicles are associated with a geographic area.

8. A system, comprising a computer usable in a vehicle, the computer having a processor and a memory, the memory storing instructions executable by the processor such that the computer is programmed to:
transmit data to a remote server indicating fuel consumption of the vehicle;
receive data from a remote server, if the fuel consumption exceeds a predetermined threshold, indicating one or more refueling stations in a geographic area of the vehicle at which the vehicle can obtain prepaid fuel, the prepaid fuel provided according to one or more futures contracts purchased on behalf of the vehicle and a plurality of other vehicles; and
planning a route specifying at least one of the one or more refueling stations.

9. The system of claim 8, wherein the vehicle and the plurality of other vehicles are each associated with the geographic area.

10. The system of claim 8, wherein the computer is further programming to actuate a human machine interface to notify a vehicle occupant when the vehicle approaches one of the one or more refueling stations.

11. The system of claim 8, wherein the computer is further programmed to transmit account information to a selected refueling station.

12. The system of claim 8, wherein the computer is further programmed to transmit a request to the remote server to identify the one or more refueling stations.

13. The system of claim 8, wherein the computer is further programmed to adjust a vehicle operating parameter relating to a fuel consumption rate upon determining that the vehicle fuel level is below a predetermined threshold.

14. A method, comprising:
receiving data from each of a plurality of vehicles in a group of vehicles indicating fuel consumption of each vehicle over a past period of time;
predicting an aggregate fuel consumption for the vehicles, and one or more fuel prices, for a future period of time; and
according to the predicted fuel consumption and one or more fuel prices, selecting one or more fuel futures contracts for purchase.

15. The method of claim 14, further comprising offering one or more of the vehicles in the group an opportunity to pre-purchase fuel based on the one or more futures contracts.

16. The method of claim 15, further comprising providing the offer to a vehicle in the group based at least in part on a prediction of the vehicle's fuel consumption for the future period of time.

17. The method of claim 15, further comprising providing, to vehicles that accept the offer, identification of one or more refueling stations from which pre-purchased fuel may be obtained.

18. The method of claim 15, further comprising providing, in response to a request from a vehicles that has accepted the offer, a route that includes one or more refueling stations from which pre-purchased fuel may be obtained.

19. The method of claim 14, further comprising determining whether one or more fuel prices have deviated from predicted fuel prices for the future period of time, and to initiate at least one of purchasing and selling fuel futures contracts based at least in part on the price deviation.

20. The method of claim 14, wherein the group of vehicles are associated with a geographic area.
